(19) United States
(12) Patent Application Publication
(10) Pub. No.: US 2026/0161682 A1
(43) Pub. Date: Jun. 11, 2026

(54) INTELLIGENT QUESTION ANSWERING METHOD AND SYSTEM BASED ON INFORMATION SECURITY PROTECTION

(71) Applicant: Jiangsu DaoAscend Technology Co., Ltd., Changzhou (CN)

(72) Inventor: Shengchao HUANG, Changzhou (CN)

(73) Assignee: Jiangsu DaoAscend Technology Co., Ltd., Changzhou (CN)

(21) Appl. No.: 19/023,573

(22) Filed: Jan. 16, 2025

(30) Foreign Application Priority Data
Dec. 10, 2024 (CN) 2024118099142

(51) Int. Cl. G06F 16/3329; G06F 21/62

(52) U.S. Cl. CPC G06F 16/33295; G06F 21/6209

(57) ABSTRACT

Disclosed is an intelligent question answering method and system based on information security protection, where the method includes: determining, upon receiving a user question, whether it is necessary to call external knowledge to respond; determining, if so, whether the user question satisfies a question layering condition; decomposing, if the user question satisfies the condition, the user question into a plurality of sub-questions by using a corresponding layering strategy; determining whether each sub-question contains confidential information separately; performing, if the sub-question contains the confidential information, leakage prevention processing on the sub-question containing the confidential information; and responding to a sub-question that does not contain the confidential information and the sub-question subjected to the leakage prevention processing. Thus, the reliability of the response and the security of information during the question-and-answer process are improved.

### CROSS-REFERENCE TO RELATED APPLICATIONS

The application claims priority to Chinese patent application No. 2024118099142, filed on Dec. 10, 2024, the entire contents of which are incorporated herein by reference.

### TECHNICAL FIELD

The present disclosure relates to the field of intelligent question answering technologies, and in particular, to an intelligent question answering method and system based on information security protection.

### BACKGROUND

In the related art, after receiving a question uploaded by a user, the question is typically responded to based on a preset answer database. However, there is often a risk of confidential information leakage during the question-and-answer process. Furthermore, responding to the question solely based on the answer database leads to lower reliability of the response.

### SUMMARY

The present disclosure provides an intelligent question answering method based on information security protection to address the above technical problems. When a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

The technical solutions adopted by the present disclosure are as follows:

Provided is an intelligent question answering method based on information security protection, including the following steps: determining, upon receiving a user question, whether it is necessary to call external knowledge to respond; determining, if it is determined that it is necessary to call the external knowledge to respond, whether the user question satisfies a question layering condition; decomposing, if it is determined that the user question satisfies the question layering condition, the user question into a plurality of sub-questions by using a corresponding layering strategy; determining whether each sub-question contains confidential information separately; performing, if it is determined that the sub-question contains the confidential information, information leakage prevention processing on the sub-question containing the confidential information; and responding to a sub-question that does not contain the confidential information and the sub-question subjected to the information leakage prevention processing.

In an embodiment of the present disclosure, determining whether it is necessary to call the external knowledge to respond specifically includes the following steps: determining whether the user question contains enterprise feature information; determining, if the user question does not contain the enterprise feature information, that it is necessary to call the external knowledge to respond; performing, if the user question contains the enterprise feature information, feature matching and security classification matching between the user question and an internal mechanism, calculating a response confidence of internal knowledge, and determining whether the response confidence is less than a first preset value; and determining, if the matching fails and the response confidence is less than the first preset value, that it is necessary to call the external knowledge to respond.

In an embodiment of the present disclosure, determining whether the user question satisfies the question layering condition specifically includes the following steps: determining whether the user question contains a symbolic keyword, whether the user question contains a question structure feature, whether the user question contains a separator, or whether the user question contains a plurality of information types; and determining, if it is determined that the user question contains the symbolic keyword, the user question contains the question structure feature, the user question contains the separator, or the user question contains the plurality of information types, that the user question satisfies the question layering condition.

In an embodiment of the present disclosure, determining whether each sub-question contains the confidential information specifically includes the following steps: acquiring a corresponding first confidential keyword database according to a field to which the sub-question belongs; performing confidential keyword identification on a to-be-identified document corresponding to the sub-question according to the first confidential keyword database to obtain a first confidential keyword contained in the to-be-identified document; determining whether meaning of the first confidential keyword determined based on the first confidential keyword database in a preset language environment is single; determining, if the meaning of the first confidential keyword in the preset language environment is single, that the first confidential keyword is the confidential information in the sub-question; and determining, if the meaning of the first confidential keyword in the preset language environment is not single, whether the first confidential keyword is the confidential information in the sub-question according to the to-be-identified document, a first meaning feature corresponding to the first confidential keyword, and a second meaning feature corresponding to the first confidential keyword.

In an embodiment of the present disclosure, the first confidential keyword database includes the first meaning feature and the second meaning feature corresponding to the confidential keyword; determining whether the first confidential keyword is the confidential information in the sub-question according to the to-be-identified document, the first meaning feature corresponding to the first confidential keyword, and the second meaning feature corresponding to the first confidential keyword specifically includes the following steps: acquiring the first meaning feature and the second meaning feature corresponding to the first confidential keyword from the first confidential keyword database according to the first confidential keyword; acquiring a third meaning feature of the first confidential keyword in the to-be-identified document; and determining whether the first confidential keyword is the confidential information in the sub-question according to the first meaning feature, the second meaning feature, and the third meaning feature.

In an embodiment of the present disclosure, determining whether the first confidential keyword is the confidential information in the sub-question according to the first meaning feature, the second meaning feature, and the third meaning feature specifically includes the following steps: calculating a first Euclidean distance between the third meaning feature and the first meaning feature, and calculating a second Euclidean distance between the third meaning feature and the second meaning feature; and determining whether the first confidential keyword is the confidential information of the sub-question according to the first Euclidean distance and the second Euclidean distance.

Provided is an intelligent question answering system based on information security protection, including: a first determination module, where the first determination module is configured to determine, upon receiving a user question, whether it is necessary to call external knowledge to respond; a second determination module, where the second determination module is configured to determine, when it is determined that it is necessary to call the external knowledge to respond, whether the user question satisfies a question layering condition; a question decomposition module, where the question decomposition module is configured to decompose, when it is determined that the user question satisfies the question layering condition, the user question into a plurality of sub-questions by using a corresponding layering strategy; a third determination module, where the third determination module is configured to determine whether each sub-question contains confidential information separately; an information processing module, where the information processing module is configured to perform, when it is determined that the sub-question contains the confidential information, violation prevention processing on the sub-question containing the confidential information; and a question response module, where the question response module is configured to respond to a sub-question that does not contain the confidential information and the sub-question subjected to the violation prevention processing.

Provided is a computer device, including a memory, a processor, and a computer program stored on the memory and executable on the processor, where the processor, when executing the computer program, implements the intelligent question answering method based on information security protection described above.

Provided is a non-transitory computer-readable storage medium storing a computer program thereon, where the program, when executed by a processor, implements the intelligent question answering method based on information security protection described above.

The beneficial effects of the present disclosure are as follows:

In the present disclosure, when a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

### BRIEF DESCRIPTION OF DRAWINGS

FIG. 1 is a flowchart of an intelligent question answering method based on information security protection according to an embodiment of the present disclosure; and

FIG. 2 is a block diagram of an intelligent question answering system based on information security protection according to an embodiment of the present disclosure.

### DETAILED DESCRIPTION OF THE EMBODIMENTS

The technical solutions in embodiments of the present disclosure will be described clearly and completely below in combination with the drawings in the embodiments of the present disclosure. Apparently, the described embodiments are only part of the embodiments of the present disclosure rather than all of the embodiments. Based on the embodiments of the present disclosure, all other embodiments obtained by those of ordinary skill in the art without creative work shall fall within the protection scope of the present disclosure.

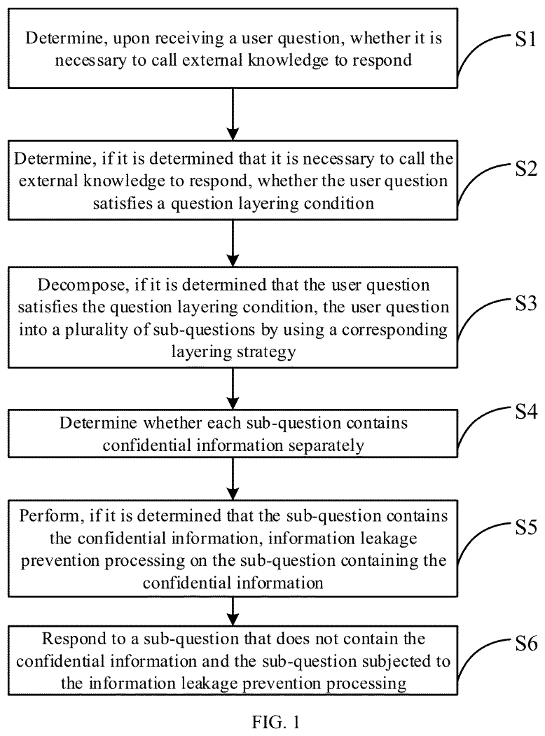

As shown in FIG. 1, an intelligent question answering method based on information security protection according to the embodiments of the present disclosure may include the following steps:

In S1, upon receiving a user question, it is determined whether it is necessary to call external knowledge to respond.

In an embodiment of the present disclosure, determining whether it is necessary to call the external knowledge to respond specifically includes the following steps:

In S11, it is determined whether the user question contains enterprise feature information.

In S12, if the user question does not contain the enterprise feature information, it is determined that it is necessary to call the external knowledge to respond.

In S13, if the user question contains the enterprise feature information, feature matching and security classification matching are performed between the user question and an internal mechanism, a response confidence of internal knowledge is calculated, and it is determined whether the response confidence is less than a first preset value.

Specifically, if the user question does not contain information about the relevant enterprise, it indicates that the response to the user question cannot be supported solely by the internal knowledge, and therefore, it is necessary to call the external knowledge to respond. If the user question contains information about the relevant enterprise, the feature matching and security classification matching are further performed, namely determining the conformity of internal features, and determining whether the confidentiality level of the user question matches a preset security classification. If the confidentiality level of the user question matches the preset security classification, the user question may only be responded to by using the internal knowledge. Additionally, the response confidence of the internal knowledge is calculated, and it is determined whether the response confidence is less than the first preset value.

Specifically, first, similar questions (questions of the same type as the current user question) responded to by using the internal knowledge in the historical record can be queried, and the maximum similarity value between each similar question and the current user question is calculated; the keyword coverage of the internal knowledge relative to the current user question is acquired, and the probability of responding to the current user question with the internal knowledge predicted based on a prediction model is acquired. Then, the response confidence of the internal knowledge is calculated according to the maximum similarity value between each similar question and the current user question, the keyword coverage of the internal knowledge relative to the current user question, and the probability of responding to the current user question with the internal knowledge predicted based on the prediction model.

The response confidence may be calculated by the following formula:

$$Z D = {k}_{1} * \frac{{a}_{2}}{{a}_{1} + \frac{1}{M}} + {k}_{2} * {K}^{{f}_{1}} + {k}_{3} * α * {g}_{1} ,$$

where ZD represents the response confidence; M represents the maximum similarity value between each similar question and the current user question; f₁ represents the keyword coverage of the internal knowledge relative to the current user question; g₁ represents the probability; a₁, a₂, and K all represent constants greater than 0, α is a regulatory factor; k₁ represents a first weight value; k₂ represents a second weight value; k₃ represents a third weight value.

In S14, if the matching fails and the response confidence is less than the first preset value, it is determined that it is necessary to call the external knowledge to respond.

If the matching fails and the response confidence is less than the first preset value, it is determined that it is necessary to call the external knowledge to respond. If the matching succeeds and the response confidence is greater than the first preset value, it is determined that the user question is responded to solely by using the internal knowledge.

Specifically, when it is determined that the user question is responded to solely by using the internal knowledge, the internal knowledge stored internally may be called, and at this time, it may be determined whether the acquisition permission for the internal knowledge is available. Whether the acquisition permission for the internal knowledge is available may be determined by authenticating the user who inputs the user question. If the acquisition permission for the internal knowledge is determined to be available, an internal response model is called for interaction, that is, the knowledge from a cache area or an answer hotspot recording area is called for response; if the acquisition permission for the internal knowledge is determined to be unavailable, a risk control audit is performed.

In S2, if it is determined that it is necessary to call the external knowledge to respond, it is determined whether the user question satisfies a question layering condition.

In S3, if it is determined that the user question satisfies the question layering condition, the user question is decomposed into a plurality of sub-questions by using a corresponding layering strategy.

In an embodiment of the present disclosure, it may be determined whether the user question contains a symbolic keyword, such as a plurality of logical relationship words like “and”, “or”, and “because”, whether the user question contains a question structure feature, such as a subject-verb-object structure, whether the user question contains a separator, or whether the user question contains a plurality of information types, such as cause analysis type and competitive situation type. If it is determined that the user question contains the symbolic keyword, the user question contains the question structure feature, the user question contains the separator, or the user question contains the plurality of information types, it is determined that the user question satisfies the question layering condition; otherwise, it is determined that the user question does not satisfy the question layering condition. When it is determined that the user question satisfies the question layering condition, the user question is decomposed into the plurality of sub-questions by using the corresponding layering strategy, that is, corresponding layering strategies are adopted for different situations.

Therefore, by dividing the user question into the plurality of sub-questions for response, the question response model used is effectively prevented from identifying the complete question, thereby improving information security.

In S4, it is separately determined whether each sub-question contains confidential information.

In an embodiment of the present disclosure, determining whether each sub-question contains the confidential information specifically includes the following steps:

In S41, a corresponding first confidential keyword database is acquired according to the field to which the sub-question belongs.

The confidential keywords in the first confidential keyword database may be confidential keywords preset by relevant enterprises. It may be understood that confidential keywords may vary across different fields.

In S42, confidential keyword identification is performed on a to-be-identified document corresponding to the sub-question according to the first confidential keyword database to obtain a first confidential keyword contained in the to-be-identified document.

The to-be-identified document corresponding to the sub-question may be identified through the confidential keywords stored in the first confidential keyword database, and the identified words are used as the first confidential keywords of the to-be-identified document.

However, the same word may have different meanings in different language environments. For example, the confidential keyword “core” in the language environments of “core technology” and “core data” may represent confidential information, whereas in the language environment of “the enterprise should put employees as the core”, it represents non-confidential information. Therefore, if the first confidential keyword is treated as confidential information solely based on the above method, the accuracy of confidential keyword identification may be significantly reduced. Thus, in the present disclosure, after the first confidential keyword contained in the to-be-identified document is identified by the above method, S43 continues to be performed.

In S43, it is determined whether the meaning of the first confidential keyword determined based on the first confidential keyword database in a preset language environment is single.

In S44, if the meaning of the first confidential keyword in the preset language environment is single, it is determined that the first confidential keyword is the confidential information in the sub-question.

The preset language environment may be a language environment preset by the relevant enterprise according to actual situations. For example, in a scenario where an enterprise has developed a new product, the preset language environment may be a language environment in which the user learns about the product from the relevant enterprise. If the meaning of the first confidential keyword in the preset language environment is single, for example, “the product is manufactured by using a certain manufacturing process”, where the meaning of the “certain manufacturing process” in the preset language environment is single, the first confidential keyword may be directly determined as the confidential information in the sub-question.

In S45, if the meaning of the first confidential keyword in the preset language environment is not single, it is determined whether the first confidential keyword is the confidential information in the sub-question according to the to-be-identified document, a first meaning feature corresponding to the first confidential keyword, and a second meaning feature corresponding to the first confidential keyword.

The first confidential keyword database includes the first meaning feature and the second meaning feature corresponding to the confidential keyword. Specifically, the first meaning feature may be a confidential information feature, and the second meaning feature may be a non-confidential information feature.

In an embodiment of the present disclosure, determining whether the first confidential keyword is the confidential information in the sub-question according to the to-be-identified document, the first meaning feature corresponding to the first confidential keyword, and the second meaning feature corresponding to the first confidential keyword specifically includes the following steps: acquiring the first meaning feature and the second meaning feature corresponding to the first confidential keyword from the first confidential keyword database according to the first confidential keyword; acquiring a third meaning feature of the first confidential keyword in the to-be-identified document; and determining whether the first confidential keyword is the confidential information in the sub-question according to the first meaning feature, the second meaning feature, and the third meaning feature.

In an embodiment of the present disclosure, determining whether the first confidential keyword is the confidential information in the sub-question according to the first meaning feature, the second meaning feature, and the third meaning feature specifically includes the following steps: calculating a first Euclidean distance between the third meaning feature and the first meaning feature, and calculating a second Euclidean distance between the third meaning feature and the second meaning feature; and determining whether the first confidential keyword is the confidential information of the sub-question according to the first Euclidean distance and the second Euclidean distance.

Specifically, the first Euclidean distance between the third meaning feature of the first confidential keyword in the to-be-identified document and the first meaning feature, and the second Euclidean distance between the third meaning feature and the second meaning feature are calculated, respectively; then the first Euclidean distance is compared to the second Euclidean distance to determine whether the first confidential keyword is the confidential information of the sub-question according to the comparison result. If the first Euclidean distance is less than the second Euclidean distance, it indicates that the third meaning feature is closer to the first meaning feature, and therefore, it may be determined that the first confidential keyword is the confidential information of the sub-question; if the first Euclidean distance is greater than the second Euclidean distance, it indicates that the third meaning feature is closer to the second meaning feature, and therefore, it may be determined that the first confidential keyword is not the confidential information of the sub-question. It may be understood that in practical applications, the first Euclidean distance will not be equal to the second Euclidean distance.

Thus, it is possible to more accurately identify whether the sub-question contains the confidential information.

In S5, if it is determined that the sub-question contains the confidential information, information leakage prevention processing is performed on the sub-question containing the confidential information.

Specifically, for different types of confidential information, different methods may be employed to perform the information leakage prevention processing. Specifically, numerical information is processed by adding numerical noise, for example, by adding a floating value within a reasonable range before and after a specific number; time fuzzification processing is performed on the time information. Furthermore, the semantic association method may also be used for processing, such as replacing “sales” with “value A” and “customer segmentation” with “market segmentation”. The encoding method may also be used for processing, for example, replacing a company name with a code or code name.

It is to be noted that after S1, it may also be determined whether the user question contains the confidential information. Depending on actual requirements, the information leakage prevention processing may be performed on the user question containing the confidential information, with specific reference to the above embodiments.

In S6, a sub-question that does not contain the confidential information and the sub-question subjected to the information leakage prevention processing are responded to.

Specifically, the sub-question that does not contain the confidential information and the sub-question subjected to the information leakage prevention processing may be responded to by using a pretrained model. The response may be provided by using a multi-engine search and multi-model question answering method. During the response, the confidential information may be identified by using the above method, and the information leakage prevention processing may be performed on the confidential information. Correction determination and answer aggregation are performed on the answers output by the models, where the answer aggregation specifically includes answer consistency verification, answer accuracy verification, answer security verification, an internal answer priority mechanism, and an answer reorganization mechanism.

In summary, according to the intelligent question answering method based on information security protection of the embodiments of the present disclosure, upon receiving a user question, it is determined whether it is necessary to call external knowledge to respond; if it is determined that it is necessary to call the external knowledge to respond, it is determined whether the user question satisfies a question layering condition; if it is determined that the user question satisfies the question layering condition, the user question is decomposed into a plurality of sub-questions by using a corresponding layering strategy; it is separately determined whether each sub-question contains confidential information; if it is determined that the sub-question contains the confidential information, information leakage prevention processing is performed on the sub-question containing the confidential information; a sub-question that does not contain the confidential information and the sub-question subjected to the information leakage prevention processing are responded to. Therefore, when a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

The present disclosure further provides an intelligent question answering system based on information security protection, which corresponds to the intelligent question answering method based on information security protection in the above embodiments.

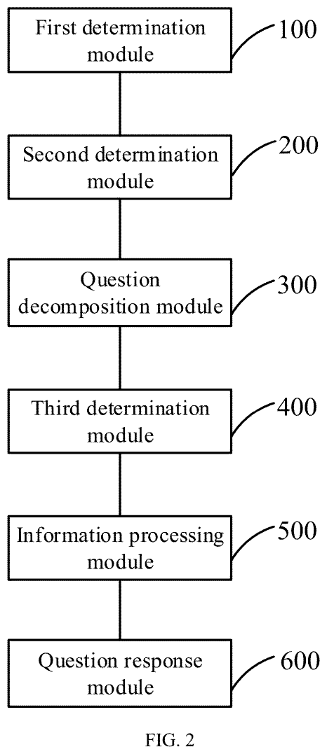

As shown in FIG. 2, the intelligent question answering system based on information security protection according to the embodiments of the present disclosure may include a first determination module 100, a second determination module 200, a question decomposition module 300, a third determination module 400, an information processing module 500, and a question response module 600.

The first determination module 100 is configured to determine, upon receiving a user question, whether it is necessary to call external knowledge to respond; the second determination module 200 is configured to determine, when it is determined that it is necessary to call the external knowledge to respond, whether the user question satisfies a question layering condition; the question decomposition module 300 is configured to decompose, when it is determined that the user question satisfies the question layering condition, the user question into a plurality of sub-questions by using a corresponding layering strategy; the third determination module 400 is configured to determine whether each sub-question contains confidential information separately; the information processing module 500 is configured to perform, when it is determined that the sub-question contains the confidential information, violation prevention processing on the sub-question containing the confidential information; the question response module 600 is configured to respond to a sub-question that does not contain the confidential information and the sub-question subjected to the violation prevention processing.

In an embodiment of the present disclosure, the first determination module 100 is specifically configured to determine whether it is necessary to call the external knowledge to respond, which specifically includes the following steps: determining whether the user question contains enterprise feature information; determining, if the user question does not contain the enterprise feature information, that it is necessary to call the external knowledge to respond; performing, if the user question contains the enterprise feature information, feature matching and security classification matching, calculating a response confidence of internal knowledge, and determining whether the response confidence is less than a first preset value; and determining, if the matching fails and the response confidence is less than the first preset value, that it is necessary to call the external knowledge to respond.

In an embodiment of the present disclosure, the second determination module 200 is specifically configured to: determine whether the user question contains a symbolic keyword, whether the user question contains a question structure feature, whether the user question contains a separator, or whether the user question contains a plurality of information types; and determine, if it is determined that the user question contains the symbolic keyword, the user question contains the question structure feature, the user question contains the separator, or the user question contains the plurality of information types, that the user question satisfies the question layering condition.

In an embodiment of the present disclosure, the third determination module 400 is specifically configured to: acquire a corresponding first confidential keyword database according to the field to which the sub-question belongs; perform confidential keyword identification on a to-be-identified document corresponding to the sub-question according to the first confidential keyword database to obtain a first confidential keyword contained in the to-be-identified document; determine whether the meaning of the first confidential keyword determined based on the first confidential keyword database in a preset language environment is single; determine, if the meaning of the first confidential keyword in the preset language environment is single, that the first confidential keyword is the confidential information in the sub-question; and determine, if the meaning of the first confidential keyword in the preset language environment is not single, whether the first confidential keyword is the confidential information in the sub-question according to the to-be-identified document, a first meaning feature corresponding to the first confidential keyword, and a second meaning feature corresponding to the first confidential keyword.

In an embodiment of the present disclosure, the first confidential keyword database includes the first meaning feature and the second meaning feature corresponding to the confidential keyword; the third determination module 400 is specifically configured to: acquire the first meaning feature and the second meaning feature corresponding to the first confidential keyword from the first confidential keyword database according to the first confidential keyword; acquire a third meaning feature of the first confidential keyword in the to-be-identified document; and determine whether the first confidential keyword is the confidential information in the sub-question according to the first meaning feature, the second meaning feature, and the third meaning feature.

In an embodiment of the present disclosure, the third determination module 400 is specifically configured to: calculate a first Euclidean distance between the third meaning feature and the first meaning feature, and calculate a second Euclidean distance between the third meaning feature and the second meaning feature; and determine whether the first confidential keyword is the confidential information in the sub-question according to the first Euclidean distance and the second Euclidean distance.

It is to be noted that details not disclosed in the intelligent question answering system based on data security protection of the embodiments of the present disclosure may refer to the intelligent question answering method based on data security protection of the embodiments of the present disclosure, which are not elaborated herein.

According to the intelligent question answering system based on data security protection of the embodiments of the present disclosure, the first determination module determines, upon receiving a user question, whether it is necessary to call external knowledge to respond; the second determination module determines, when it is determined that it is necessary to call the external knowledge to respond, whether the user question satisfies a question layering condition; the question decomposition module decomposes, when it is determined that the user question satisfies the question layering condition, the user question into a plurality of sub-questions by using a corresponding layering strategy; the third determination module determines whether each sub-question contains confidential information separately; the information processing module performs, when it is determined that the sub-question contains the confidential information, violation prevention processing on the sub-question containing the confidential information; the question response module responds to a sub-question that does not contain the confidential information and the sub-question subjected to the violation prevention processing. Therefore, when a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

Corresponding to the above embodiments, the present disclosure further provides a computer device.

The computer device of the embodiments of the present disclosure includes a memory, a processor, and a computer program stored on the memory and executable on the processor, where the processor, when executing the computer program, implements the intelligent question answering method based on data security protection of the above embodiments.

According to the computer device of the embodiments of the present disclosure, when a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

Corresponding to the above embodiments, the present disclosure further provides a non-transitory computer-readable storage medium.

The non-transitory computer-readable storage medium of the embodiments of the present disclosure stores a computer program, where the program, when executed by a processor, implements the intelligent question answering method based on data security protection described above.

According to the non-transitory computer-readable storage medium of the embodiments of the present disclosure, when a user question is received, the user question is responded to by incorporating external knowledge, thereby improving the reliability of the response. Additionally, when the user question is responded to, the user question is decomposed first, and then the response is provided after ensuring that the decomposed sub-questions do not contain confidential information, thereby significantly enhancing the security of information during the question-and-answer process.

In the description of the present disclosure, the terms “first” and “second” are used for descriptive purposes only and are not to be construed as indicating or implying relative importance or implicitly indicating the number of technical features indicated. Therefore, features defined with “first” or “second” may explicitly or implicitly include one or more of the features. The term “plurality” means two or more, unless explicitly defined otherwise.

In the present disclosure, unless explicitly specified and defined otherwise, terms such as “mount”, “link”, “connect”, and “fix” are to be understood in a broad sense. For example, “connect” may refer to a fixed connection, a detachable connection, or integration; a mechanical connection or an electrical connection; a direct connection or an indirect connection through an intermediate; or an internal communication between two elements or an interaction between two elements. For those of ordinary skill in the art, the specific meanings of the above terms in the present disclosure can be construed according to specific situations.

In the present disclosure, unless otherwise explicitly specified and limited, a first feature being “on” or “under” a second feature may include the first and second features being in direct contact, or the first and second features being in indirect contact through an intervening medium. Furthermore, the first feature “over”, “above”, and “on” the second feature may be that the first feature is directly above or diagonally above the second feature, or simply means that the first feature has a greater horizontal height than the second feature. The first feature “under”, “below”, and “beneath” the second feature may be that the first feature is directly below or diagonally below the second feature, or simply means that the first feature has a smaller horizontal height than the second feature.

In the description of the specification, the description of reference terms “one embodiment”, “some embodiments”, “an example”, “a specific example”, or “some examples” and the like means that specific features, structures, materials, or characteristics described in connection with the embodiments or examples are included in at least one embodiment or example of the present disclosure. In the specification, the schematic expressions of the above terms are not necessarily directed to the same embodiment or example. Moreover, the specific features, structures, materials, or characteristics described may be combined in a suitable manner in any one or more embodiments or examples. In addition, various embodiments or examples and features of various embodiments or examples described in the specification can be combined by those skilled in the art without contradiction.

In addition, each functional unit in the embodiments of the present disclosure may be integrated in one processing module, or each unit may physically exist alone, or two or more units may be integrated into one module. The integrated module may be implemented in the form of hardware, or in the form of a software functional module. The integrated module, if implemented in the form of a software functional module and sold or used as an independent product, may also be stored in a computer-readable storage medium.

Although the embodiments of the present disclosure have been shown and described above, it will be understood that the above embodiments are exemplary and not to be construed as limiting the present disclosure. Those of ordinary skill in the art can make changes, modifications, substitutions, and variations to the above embodiments within the scope of the present disclosure.

1. An intelligent question answering method based on information security protection, comprising the following steps:
determining, upon receiving a user question, whether it is necessary to call external knowledge to respond based on at least one of: whether the user question contains enterprise feature information, and whether a response confidence of internal knowledge calculated based on a maximum similarity value between historical similar questions and the user question, a keyword coverage of the internal knowledge relative to the user question, and a probability predicted by a prediction model;
determining, if it is determined that it is necessary to call the external knowledge to respond, whether the user question satisfies a question layering condition by determining whether the user question contains at least one of: a symbolic keyword, a question structure feature, a separator, or a plurality of information types;
decomposing, if it is determined that the user question satisfies the question layering condition, the user question into a plurality of sub-questions based on the at least one detected feature;
determining whether each sub-question contains confidential information, separately, wherein determining whether each sub-question contains confidential information comprises:
acquiring a first confidential keyword database according to a field to which the sub-question belongs;
performing confidential keyword identification on a to-be-identified document corresponding to the sub-question according to the first confidential keyword database to obtain a first confidential keyword contained in the to-be-identified document;
determining, based on the first confidential keyword database, whether the first confidential keyword has a single meaning in a preset language environment;
determining that the first confidential keyword is the confidential information in the sub-question when the meaning of the first confidential keyword has the single meaning in the preset language environment; and
determining whether the first confidential keyword is the confidential information in the sub-question when the meaning of the first confidential keyword does not have the single meaning in the preset language environment, based on the to-be-identified document, a confidential-information semantic feature corresponding to the first confidential keyword, and a non-confidential-information semantic feature corresponding to the first confidential keyword;
performing, if it is determined that the sub-question contains the confidential information, information leakage prevention processing on the sub-question containing the confidential information, wherein the information leakage prevention processing comprises at least one of: adding numerical noise to numerical information contained in the confidential information, performing time fuzzification on time information contained in the confidential information, replacing the confidential information using semantic association, or replacing an company name with a code; and
generating a response by processing a sub-question that does not contain the confidential information and the sub-question subjected to the information leakage prevention processing using a question answering model.

2. The intelligent question answering method based on information security protection according to claim 1, wherein determining whether it is necessary to call the external knowledge to respond specifically comprises the following steps:
determining, in response to the user question not containing the enterprise feature information, to call the external knowledge to respond;
performing, in response to the user question containing the enterprise feature information, feature matching and security classification matching between the user question and an internal mechanism, calculating a response confidence of internal knowledge, and determining whether the response confidence is less than a first preset value; and
determining, in response to the matching failing and the response confidence being less than the first preset value, to call the external knowledge to respond.

3. The intelligent question answering method based on information security protection according to claim 1, wherein determining whether the user question satisfies the question layering condition comprises the following steps:
determining whether the user question contains at least one selected from the group consisting of the symbolic keyword, the question structure feature, the separator, and the plurality of information types; and
determining, in response to determining the user question contains at least one selected from the group consisting of the symbolic keyword, the question structure feature, the separator, and the plurality of information types, that the user question satisfies the question layering condition.

4. (canceled)

5. The intelligent question answering method based on information security protection according to claim 1, wherein the first confidential keyword database comprises the confidential-information semantic feature corresponding to the first confidential keyword and the non-confidential-information semantic feature corresponding to the first confidential keyword; and
wherein determining whether the first confidential keyword is the confidential information in the sub-question according to the to-be-identified document, the confidential-information semantic feature corresponding to the first confidential keyword, and the non-confidential-information semantic feature corresponding to the first confidential keyword comprises the following steps:
acquiring the confidential-information semantic feature and the non-confidential-information semantic feature corresponding to the first confidential keyword from the first confidential keyword database according to the first confidential keyword;
acquiring a contextual semantic feature of the first confidential keyword in the to-be-identified document; and
determining whether the first confidential keyword is the confidential information in the sub-question according to the confidential-information semantic feature, the non-confidential-information semantic feature, and the contextual semantic feature.

6. The intelligent question answering method based on information security protection according to claim 5, wherein determining whether the first confidential keyword is the confidential information in the sub-question according to the confidential-information semantic feature, the non-confidential-information semantic feature, and the contextual semantic feature comprises the following steps:
calculating a first Euclidean distance between the contextual semantic feature and the confidential-information semantic feature, and calculating a second Euclidean distance between the contextual semantic feature and the non-confidential-information semantic feature; and
determining whether the first confidential keyword is the confidential information in the sub-question according to the first Euclidean distance and the second Euclidean distance, wherein the first confidential keyword is determined to be the confidential information if the first Euclidean distance is less than the second Euclidean distance.

7. (canceled)

8. A computer device, comprising a memory, a processor, a confidential keyword database, and a computer program stored on the memory and executable on the processor, wherein the processor, when executing the computer program, implements the intelligent question answering method based on information security protection according to claim 1.
